(19) United States
(12) Patent Application Publication
(10) Pub. No.: US 2007/0165795 A1
(43) Pub. Date: Jul. 19, 2007

(54) SYSTEM AND METHOD FOR PROVIDING USER-REQUESTED INFORMATION

(75) Inventor: Benjamin Charles Haynor, Mahtomedi, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(73) Assignee: TAGGART COMMUNICATIONS, LLC, Minneapolis, MN (US)

(21) Appl. No.: 11/624,782

(22) Filed: Jan. 19, 2007

Related U.S. Application Data
(60) Provisional application No. 60/760,097, filed on Jan. 19, 2006.

(51) Int. Cl. H04M 1/64

(52) U.S. Cl. 379/88.01; 379/114.2; 379/88.13

(57) ABSTRACT

A system and method for providing information to a mobile unit user in response to requests made by the user. An exemplary system may allow a cellular phone user to retrieve text and/or image files, for example, by accessing an interactive voice response (IVR) system, which generates and sends SMS, MMS and/or WAP messages to the cellular phone based on information identification codes and/or other input entered into the IVR by the user. In some embodiments of the invention, no prior setup is required by the mobile unit user in order to receive the requested information.

### CROSS-REFERENCE TO RELATED APPLICATIONS

The present application claims priority to U.S. Provisional Application No. 60/760,097, filed Jan. 19, 2006, incorporated herein by reference in its entirety.

### FIELD

The invention relates generally to an interactive voice response (IVR) system, and more particularly to the use of text and picture message responses to user requests for information from an IVR system.

### BACKGROUND

Short Message Service (SMS) is a feature available on most wireless phones that allows users to send or receive short alphanumeric messages (e.g., “text” messages). Basic SMS messages are addressed to a mobile phone number and can be up to 160 characters in length. Most U.S. carriers now allow sending to mobile phone numbers of other carriers. Most phones and carriers also support sending SMS from a phone directly to an email address. It was created as part of the GSM Phase 1 standard. More information can be found at http://www.gsm-technology.com/gsm.php/en,unlock,_subpage_id,smsfaq.html

Multimedia Message Service (MMS) and Wireless Application Protocol (WAP) are similar to SMS in that they allow the transfer of messages to wireless phones. However, MMS and WAP differ from SMS in that they can also deliver other forms of digital data, including messages in the form of graphics (e.g., picture messages), video clips, sound files, and/or programs over wireless networks.

SMSCs and MMSCs are systems whose function is to deliver SMS, MMS, and/or WAP messages to wireless users, regardless of wireless carrier.

There are two classifications of message transfer using these services, mobile-terminated (MT) and mobile-originated (MO). MT messages are SMS or MMS messages with a final destination, for example, of a mobile handset. MO messages are SMS or MMS messages that originate from such a mobile handset.

Interactive Voice Response (IVR) refers to a communications system that permits users to enter information into a programmed device which permits the choice of several options based on the input, generally using a telephone keypad or the equivalent. Prompts to the user are provided by recorded voice or the equivalent.

There is a need for a system and method to send MT SMS, MMS, and WAP messages based upon user commands entered within an IVR.

### SUMMARY

Certain embodiments of the invention include a method for providing text and/or information in other formats (e.g., graphics image files, sound files, etc.) to a mobile unit in response to inputs or requests made by the mobile unit user. In certain preferred embodiments, a mobile unit user receives text and/or information in other formats displayed for viewing on a mobile unit (e.g., a cellular phone) in response to requests made to an interactive voice response (IVR) system. In certain embodiments, requests include information identification codes made available by marketers and promoters of goods and services. Such requests may be made by pressing appropriate keypad entries in response to verbal instructions provided by the IVR, for example. In certain embodiments, a mobile unit user receives text and/or information in various other formats, via SMS, MMS or WAP respectively, in response to the information identification codes (and other inputs) entered by the user.

An embodiment of the invention includes a system that provides text and/or information in other formats to a user of a mobile unit (e.g., cellular phone) in response to inputs or requests made by the mobile unit user. In certain embodiments, the system includes an IVR system which is adapted to receive requests for information from a mobile unit user. In certain embodiments, the IVR system is adapted to receive requests in the form of an information identification code. In certain embodiments, a system control unit provides text and/or information in other formats to the mobile unit user corresponding to the information identification code. In certain preferred embodiments, the text and/or information in other formats are provided via SMS, MMS or WAP.

### BRIEF DESCRIPTION OF THE DRAWINGS

FIG. 1 is a combined block diagram and flowchart of a system according to an embodiment of the invention; and

FIG. 2 is a flowchart of a method according to an embodiment of the invention.

### DETAILED DESCRIPTION OF THE PREFERRED EMBODIMENT

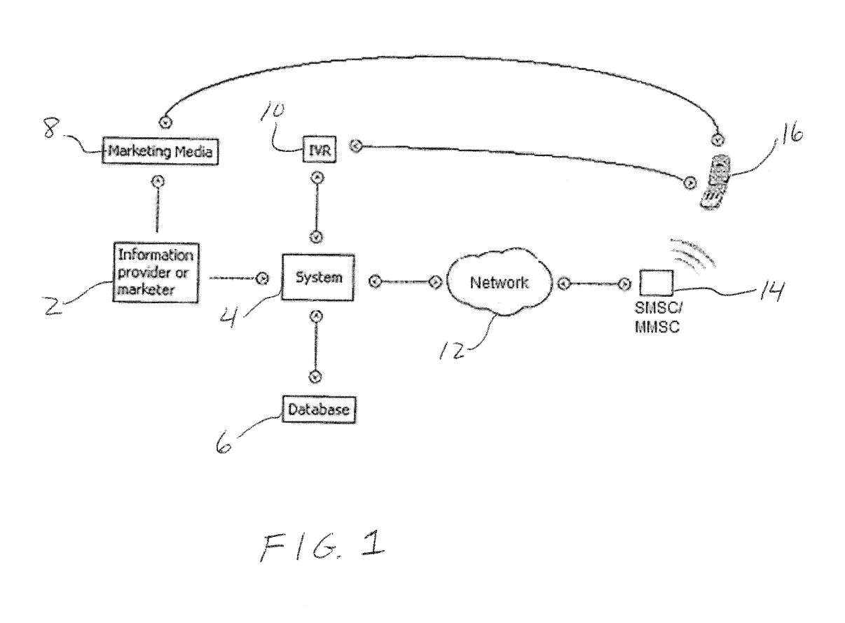

As shown in FIG. 1, one embodiment of the invention comprises some or all of the following elements:
(2)—an information provider or marketer.
(4)—a system control unit.
(6)—a database.
(8)—media for marketing products or services, such as billboards, television, the Internet, radio, printed advertisements, etc.
(10)—an interactive voice response (IVR) system.
(12)—a network, such as the Internet.
(14)—SMSC/MMSC.
(16)—a mobile unit such as a cellular telephone capable of receiving SMS, MMS or WAP messages.

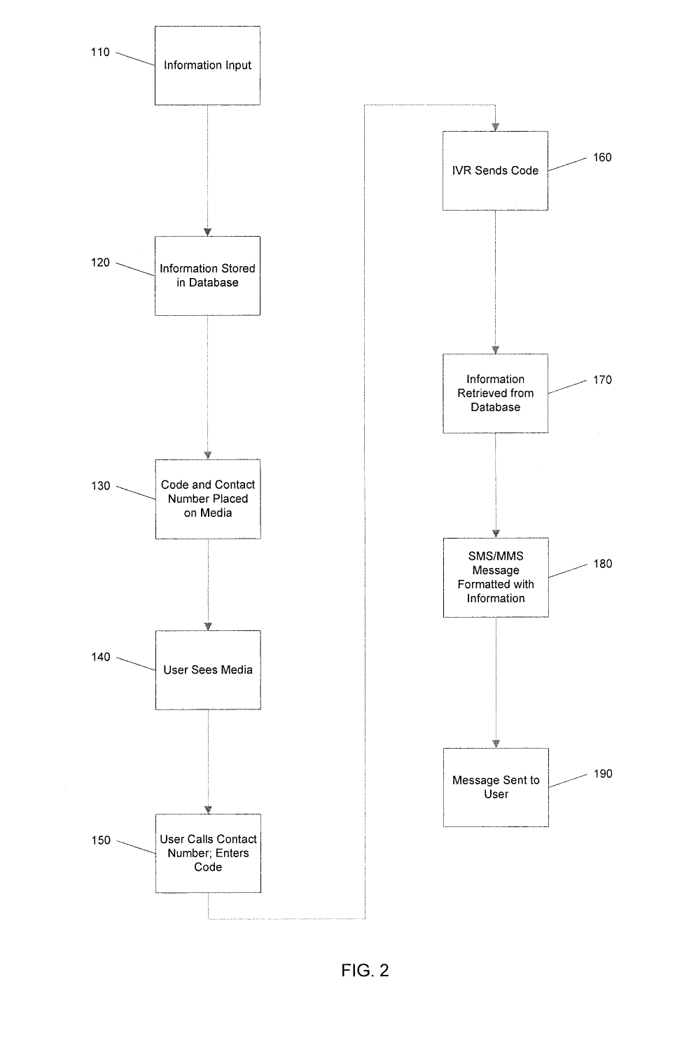

The steps of a method according to one embodiment of the invention are illustrated in FIG. 2 and described as follows (the order of steps may vary from that shown except when such variation renders the method inoperative):

Step 110—the information provider or marketer 2 enters data on a product or service code into the system control unit 4. In the case of text (SMS) messages, this may include alphanumeric information describing the product or service. In the case of a picture (MMS or WAP) message, this may include uploaded binary pictures of the product or service. The information input may include various combinations of text, graphic images, and other data file formats according to certain embodiments.

Step 120—the system control unit 4 stores information in the information database 6 with the unique product or service code previously entered by the marketer 2.

Step 130—the information provider or marketer 2 places advertisements on various marketing media 8, containing the unique product or service code and IVR phone number that wireless users may call to receive information in the form of voice recorded information, text (SMS) message information, or picture (MMS or WAP) message format.

Step 140—the user of the mobile unit 16 sees the marketing media 8.

Step 150—the user of the mobile unit 16 calls the IVR phone number, typically, but not exclusively, by a cellular telephone, and enters the unique product or service code.

Step 160—the IVR captures the mobile unit's unique caller ID, and the user's unique product or service code entry, and passes this to the system control unit 4.

Step 170—the system control unit 4 connects to the database 6, looks up the unique product or service code entered by the wireless user, and retrieves the appropriate information to formulate a message that is typically, but not exclusively, a text (SMS) and/or picture (MMS or WAP) message.

Step 180—the system control unit 4 formats the SMS, MMS or WAP message, addresses it to the mobile unit's unique caller ID, and sends it over a network, for example, the Internet, to SMSC/MMSC.

Step 190—SMSC/MMSC delivers the appropriate text and/or picture message to the mobile unit 16 for visual display.

In some embodiments, the message delivered to the mobile unit 16 may include prompts for further information request commands. For example, the user may be prompted to make a selection (e.g., from a menu of options) to view additional information by pressing an appropriate keypad entry on the mobile unit. The additional information may also be communicated to the mobile unit in the form of an SMS, MMS or WAP message in certain embodiments of the invention. In many embodiments of the invention, no prior setup is required by the mobile unit user in order to receive the requested information.

With continued reference to FIG. 1 and FIG. 2, the following is an example of the use of the system, using a hypothetical marketing campaign for “Ben's Burgers,” product code “1234,” and “1-800-555-5555” as the IVR phone number.

110. Marketing firm 2 enters menu and directions to a restaurant “Ben's Burgers” into the system control unit 4. In this example, the text (SMS) message could be:
“Best burgers in town.
California Burger $6.95
Cajun Burger $7.95
BBQ Bacon Burger $7.95
Cheeseburger $5.95
. . . many other great menu choices!
White Bear Ave exit, just off the highway to the south.”

In the case of a picture message (MMS), this could be a picture of the interior of the restaurant, or the different menu items available.

120. The system control unit 4 stores information in the information database 6 with a unique product or service code, in this case, “1234.”

130. The information provider or marketer 2 places advertisements on marketing media 8, for example, on billboards, containing a unique product or service code (e.g., “1234”) and IVR phone number (e.g., “1-800-555-5555”) that wireless users may call to receive information about Ben's Burgers.

140. Wireless user sees Ben's Burgers billboard, with the IVR number of “1-800-555-5555,” and with product code “1234.”

150. Wireless user calls “1-800-555-5555” on the mobile unit 16, enters code “1234” when prompted, and requests both the menu and a picture of the restaurant.

160. IVR 10 captures the mobile unit's unique caller ID, the wireless user's product or service code entry (e.g., “1234”), and any other of the user's information request commands, and sends this information to the system control unit 4.

170. The system control unit 4 connects to the database 6, looks up information in the database corresponding to code “1234,” and retrieves the appropriate information to formulate the text and picture messages, that being the text of the restaurant's menu and prices in this example, as well as the picture of the interior of the restaurant in this case.

180. The system control unit 4 formats the SMS, MMS or WAP message for delivery by the SMSC/MMSC 14, addresses it to the mobile unit's unique caller ID and sends it over a network 12, for example, the Internet, to the SMSC/MMSC 14.

190. The SMSC/MMSC 14 delivers the message to the user's mobile unit 16. The user receives the text message containing the menu and directions, and a picture message of the interior of the restaurant. In many embodiments of the invention, no prior setup is required by the mobile unit user in order to request and receive the information.

Thus, embodiments of a SYSTEM AND METHOD FOR PROVIDING USER-REQUESTED INFORMATION are described. The invention may be embodied in other specific forms without departing from the spirit or essential attributes thereof, and it is therefore desired that the present embodiment be considered in all respects as illustrative and not restrictive.

What is claimed is:

1. A method of providing user-requested information, the method comprising:
providing an interactive voice response system accessible by a mobile unit;
receiving an information identification code from the mobile unit in response to a prompt from the interactive voice response system;
retrieving from a database information corresponding to the information identification code;
creating a message adapted to be displayed on the mobile unit, wherein the message comprises the information; and
sending the message to the mobile unit.

2. The method of claim 1, wherein the mobile unit is a cellular phone.

3. The method of claim 1, wherein sending the message to the mobile unit occurs at least partially through the Internet.

4. The method of claim 1, wherein the information comprises text.

5. The method of claim 4, wherein the message is an SMS message.

6. The method of claim 1, wherein the information comprises an image file.

7. The method of claim 6, wherein the message is an MMS message.

8. The method of claim 6, wherein the message is a WAP message.

9. A system for providing user-requested information, the system comprising:
an interactive voice response system, adapted to receive an information identification code from a mobile unit;
a database unit adapted to store information associated with the information identification code; and
a system control unit, the system control unit being adapted to
receive the information identification code from the interactive voice response system,
retrieve the information from the database based on the information identification code received,
create a message for display on the mobile unit, the message including the information, and
send the message to the mobile unit.

10. The system of claim 9, wherein the mobile unit is a cellular phone.

11. The system of claim 9, wherein the system control unit is adapted to send the message to the mobile unit at least partially via the Internet.

12. The system of claim 9, wherein the information comprises text.

13. The system of claim 12, wherein the message is an SMS message.

14. The system of claim 13 wherein the message is a mobile terminated (MT) SMS message.

15. The system of claim 9, wherein the information comprises an image file.

16. The system of claim 15, wherein the message is an MMS message.

17. The system of claim 16, wherein the message is a mobile terminated (MT) MMS message.

18. The system of claim 15, wherein the message is a WAP message.

19. The system of claim 9 wherein the interactive voice response system is adapted to prompt a user of the mobile unit to select receiving the piece of information as recorded voice information.

20. The system of claim 9 wherein the interactive voice response system is adapted to prompt a user of the mobile unit to enter a unique caller ID for a second mobile unit, the system control unit being further adapted to send the message to the second mobile unit.
